(19) United States
(12) Patent Application Publication
(10) Pub. No.: US 2007/0042730 A1
(43) Pub. Date: Feb. 22, 2007

(54) Terrestrial-Digital Multimedia Broadcasting And Digital Audio Broadcasting Low Intermediate Frequency Receiver

(76) Inventors: Bonkee Kim, Seongnam (KR); Bo-Eun Kim, Yongin (KR)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 11/463,643

(22) Filed: Aug. 10, 2006

(30) Foreign Application Priority Data
Aug. 17, 2005 (KR) 10-2005-0075309

(51) Int. Cl. H04B 7/08; H04B 1/18

(52) U.S. Cl. 455/132; 455/334; 455/280

(57) ABSTRACT

Provided is a terrestrial-digital multimedia broadcasting (T-DMB) and digital audio broadcasting (DAB) low intermediate frequency (IF) receiver. A T-DMB and DAB low IF receiver comprises a low noise amplifier (LNA), an image rejection down-conversion mixer, a low pass filter, an amplifier, a local oscillator, a phase-locked loop, and at least one high pass filter. Particularly, the LNA, the image rejection down-conversion mixer, the low pass filter, the amplifier, the local oscillator, the phase-locked loop, and the high pass filter are integrated in a monolithic semiconductor integrated circuit substrate. The T-DMB and DAB low IF receiver allows a removal of a conventional SAW filter without degrading the performance of the receiver. Thus, the T-DMB and DAB low IF receiver can be easily integrated into a single and manufactured at low costs.

This non-provisional application claims priority under 35 U.S.C. §119(a) on Patent Application No. 10-2005-0075309 filed in Korea on Aug. 17, 2005, the entire contents of which are hereby incorporated by reference.

### BACKGROUND OF THE INVENTION

1. Field of the Invention

The present invention relates to a terrestrial-digital multimedia broadcasting (T-DMB) and digital audio broadcasting (DAB) receiver.

2. Description of the Background Art

A conventional receiver uses a super-heterodyne mode that converts a received signal into a signal at an intermediate frequency (IF) band and then into a signal at a baseband.

Generally, IF is used to improve the performance of the receiver using a filter that effectively filters a specific frequency band. A surface acoustic wave (SAW) filter is usually used as the aforementioned filter.

A conventional DAB receiver uses an L-band of the radio frequency (RF) spectrum ranging from 1,450 MHz to 1,492 MHz. On the other hand, a conventional T-DMB receiver uses a Band-III band of the RF spectrum ranging from 174 MHz to 245 MHz. Also, the conventional DAB and T-DMB receivers use an IF of 38.912 MHz and have a channel bandwidth of 1.536 MHz.

FIG. 1 illustrates a simplified block diagram of a conventional receiver.

A RF signal that is received by an antenna 101 is supplied to a low noise amplifier (LNA) 102. An output signal of the LNA 102 is transmitted to a mixer 103, which subsequently moves the transmitted signal to the IF band.

An output signal of the mixer 103 passes through a band-pass filter 104 and is transmitted to an amplifier 105. A demodulator 107 receives an output signal of the amplifier 105. A local oscillator 108 generates a frequency to make the received RF signal move to the IF band and, supplies the generated frequency to the mixer 103.

The band-pass filter 104 is a SAW filter that is generally used in the typical super-heterodyne mode.

The LNA 102, the mixer 103, the amplifier 105, and the local oscillator 108 are integrated into a single receiver chip 106, and the band-pass filter 104 (i.e., the SAW filter) is disposed outside the receiver chip 106.

The SAW filter is a filter for telecommunications using mechanical vibrations from a piezoelectric substrate. On the piezoelectric substrate, two slit patterned metal plates are arranged to face in opposite direction on both sides of the piezoelectric substrate. When an electric signal is inputted from one direction, a surface acoustic wave is generated on the piezoelectric substrate.

The surface acoustic wave, which is also called “mechanical vibration,” is converted into an electric signal in the opposite direction to the input direction. If the surface acoustic wave of the piezoelectric substrate has a different frequency from the inputted electric signal, the signal transmission does not take place. As a result, the SAW filter functions as a band-pass filter that passes only a frequency identical to a mechanical-physical frequency of the SAW filter.

As compared with a filter using the LC resonance principle, the SAW filter generally passes a very narrow bandwidth, and thus, can be effective to select a desired signal frequency with a narrow bandwidth since the SAW filter can almost completely filter out unnecessary signal frequency.

However, the SAW filter is a mechanical filter, and thus, often has a limitation in reducing the volume. As illustrated in FIG. 1, in the case that the receiver using the band-pass filter 104 (i.e., the SAW filter) is implemented in a single integration chip, the SAW filter usually cannot be integrated therein, thereby being placed outside the receiver chip 106.

Since the SAW filter is expensive, the total manufacturing cost for the receiver often increases.

Therefore, when such a receiver using the SAW filter is implemented to a mobile telecommunications terminal, the SAW filter may become a main factor that increases the price of the receiver. Also, it may be difficult to integrate the receiver into a single chip.

A receiver that receives a single RF signal by a single antenna can receive a single corresponding frequency band. Therefore, when at least two frequency bands need to be received, a number of receiver chips are necessary to receive the frequency bands individually. As a result, the overall volume of the telecommunications devices may increase, and the manufacturing costs may also increase.

Also, the removal of the SAW filter may result in degradation of the performance of the receiver.

### SUMMARY OF THE INVENTION

Accordingly, one embodiment of the present invention is directed to provide a T-DMB and DAB low IF receiver that can be easily integrated into a single chip and manufactured at low costs.

Another embodiment of the present invention is directed to provide a dual band T-DMB and DAB low IF receiver that can be easily integrated into a single chip and manufactured at low costs by receiving signals at two frequency bands.

Still another embodiment of the present invention is directed to provide a T-DMB and DAB low IF receiver and a dual band T-DMB and DAB low IF receiver, wherein a SAW filter is removed without degrading the performance of the T-DMB and DAB low IF receiver and the dual band T-DMB and DAB low IF receiver.

A terrestrial-digital multimedia broadcasting (T-DMB) and digital audio broadcasting (DAB) low intermediate frequency (IF) receiver according to an embodiment of the present invention comprises a low noise amplifier (LNA) suppressing a noise signal of a received radio frequency (RF) signal and amplifying the received RF signal, wherein the received RF signal includes a T-DMB signal or a DAB signal; an image rejection down-conversion mixer converting a frequency band of the RF signal outputted from the LNA into a low IF band; a low pass filter filtering a low frequency band of a signal outputted from the image rejection down-conversion mixer; an amplifier amplifying a signal outputted from the low pass filter; a local oscillator generating a frequency for the down-conversion and supplying the frequency to the image rejection down-conversion mixer; a phase-locked loop moving the frequency of the local oscillator to a certain frequency and locking the certain frequency; and at least one high pass filter disposed within a signal passage comprising the image rejection down-conversion mixer, the low pass filter and the amplifier and removing a low frequency component generated at the signal passage, wherein the LNA, the image rejection down-conversion mixer, the low pass filter, the amplifier, the local oscillator, the phase-locked loop, and the high pass filter are integrated in a monolithic semiconductor integrated circuit substrate.

Consistent with the embodiment of the embodiment of the present invention, the high pass filter may have a cut-off frequency of about 0.192 MHz or less.

Consistent with the embodiment of the present invention, the LNA and the amplifier may comprise one of a programmable gain amplifier and a variable gain amplifier.

Consistent with the embodiment of the present invention, the received RF signal may comprise a signal at one frequency band of a Band-III ranging between about 174 MHz and about 245 MHz or an L-band ranging between about 1,450 MHz and about 1,492 MHz.

A terrestrial-digital multimedia broadcasting (T-DMB) and digital audio broadcasting (DAB) low intermediate frequency (IF) receiver according to another embodiment of the present invention comprises a low noise amplifier (LNA) suppressing a noise signal of a received radio frequency (RF) signal and amplifying the received RF signal, wherein the received RF signal includes a T-DMB signal or a DAB signal; an image rejection down-conversion mixer converting a frequency band of the RF signal outputted from the LNA into a low IF band; a low pass filter filtering a low frequency band of a signal outputted from the image rejection down-conversion mixer; an amplifier amplifying a signal outputted from the low pass filter; a local oscillator generating a frequency for the down-conversion and supplying the frequency to the image rejection down-conversion mixer; a phase-locked loop moving the frequency of the local oscillator to a certain frequency and locking the certain frequency; and a DC offset calibrator removing a frequency component at a low frequency band, wherein the LNA, the image rejection down-conversion mixer, the low pass filter, the amplifier, the local oscillator, the phase-locked loop, and the DC offset calibrator are integrated in a monolithic semiconductor integrated circuit substrate.

Consistent with the other embodiment of the present invention, the DC offset calibrator may have a cut-off frequency of about 0.192 MHz or less.

Consistent with the other embodiment of the present invention, the LNA and the amplifier may comprise one of a programmable gain amplifier and a variable gain amplifier.

Consistent with the other embodiment of the present invention, the received RF signal may comprise a signal at one frequency band of a Band-III ranging between about 174 MHz and about 245 MHz or an L-band ranging between about 1,450 MHz and about 1,492 MHz.

A dual band terrestrial-digital multimedia broadcasting (T-DMB) and digital audio broadcasting (DAB) low intermediate frequency (IF) receiver according to still another embodiment of the present invention comprises a first low noise amplifier (LNA) suppressing a noise signal of a received first radio frequency (RF) signal and amplifying the received first RF signal, wherein the received first RF signal includes a T-DMB signal; a second low noise amplifier (LNA) suppressing a noise signal of a received second radio frequency (RF) signal and amplifying the received second RF signal, wherein the received second RF signal includes a DAB signal; an image rejection down-conversion mixer converting frequency bands of the first and second RF signals respectively outputted from the first and second LNAs into a low IF band; a low pass filter filtering a low frequency band of a signal outputted from the image rejection down-conversion mixer; an amplifier amplifying a signal outputted from the low pass filter; a local oscillator generating a frequency for the down-conversion and supplying the frequency to the image rejection down-conversion mixer; a phase-locked loop moving the frequency of the local oscillator to a certain frequency and locking the certain frequency; and at least one high pass filter disposed within a signal passage comprising the image rejection down-conversion mixer, the low pass filter and the amplifier and removing a low frequency component generated at the signal passage, wherein the first and second LNAs, the image rejection down-conversion mixer, the low pass filter, the amplifier, the local oscillator, the phase-locked loop, and the high pass filter are integrated in a monolithic semiconductor integrated circuit substrate.

Consistent with still the other embodiment of the present invention, the high pass filter may have a cut-off frequency of about 0.192 MHz or less.

Consistent with still the other embodiment of the present invention, the first and second LNAs and the amplifier may comprise one of a programmable gain amplifier and a variable gain amplifier.

Consistent with still the other embodiment of the present invention, the first RF signal may comprise a signal at a Band-III frequency band ranging between about 174 MHz and about 245 MHz; and the second RF signal may comprise a signal at an L-band frequency band ranging between about 1,450 MHz and about 1,492 MHz.

A dual band terrestrial-digital multimedia broadcasting (T-DMB) and digital audio broadcasting (DAB) low intermediate frequency (IF) receiver according to further another embodiment of the present invention comprises a first low noise amplifier (LNA) suppressing a noise signal of a received first radio frequency (RF) signal and amplifying the received first RF signal, wherein the received first RF signal includes a T-DMB signal; a second low noise amplifier (LNA) suppressing a noise signal of a received second radio frequency (RF) signal and amplifying the received second RF signal, wherein the received second RF signal includes a DAB signal; an image rejection down-conversion mixer converting a frequency band of the RF signal outputted from the LNA into a low IF band; a low pass filter filtering a low frequency band of a signal outputted from the image rejection down-conversion mixer; an amplifier amplifying a signal outputted from the low pass filter; a local oscillator generating a frequency for the down-conversion and supplying the frequency to the image rejection down-conversion mixer; a phase-locked loop moving the frequency of the local oscillator to a certain frequency and locking the certain frequency; and a DC offset calibrator removing a frequency component at a low frequency band, wherein the first and second LNAs, the image rejection down-conversion mixer, the low pass filter, the amplifier, the local oscillator, the phase-locked loop, and the DC offset calibrator are integrated in a monolithic semiconductor integrated circuit substrate.

Consistent with further the other embodiment of the present invention, the DC offset calibrator may have a cut-off frequency of about 0.192 MHz or less.

Consistent with further the other embodiment of the present invention, the first and second LNAs and the amplifier may comprise one of a programmable gain amplifier and a variable gain amplifier.

Consistent with further the other embodiment of the present invention, the first RF signal may comprise a signal at a Band-III frequency band ranging between about 174 MHz and about 245 MHz; and the second RF signal may comprise a signal at an L-band frequency band ranging between about 1,450 MHz and about 1,492 MHz.

### BRIEF DESCRIPTION OF THE DRAWINGS

The invention will be described in detail with reference to the following drawings in which like numerals refer to like elements.

FIG. 1 illustrates a simplified block diagram of a receiver using a conventional SAW filter;

FIG. 2a illustrates a simplified block diagram of a T-DMB and DAB low IF receiver according to an embodiment of the present invention;

FIG. 2b illustrates a simplified block diagram of a T-DMB and DAB low IF receiver comprising a high pass filter according to an embodiment of the present invention;

FIG. 3 illustrates a frequency component of a signal passing through an LNA of a T-DMB and DAB low IF receiver according to an embodiment of the present invention;

FIG. 4 illustrates a frequency component of a signal passing through an image rejection down-conversion mixer of a T-DMB and DAB low IF receiver according to an embodiment of the present invention;

FIG. 5 illustrates a frequency component of a signal passing through a low pass filter of a T-DMB and DAB low IF receiver according to an embodiment of the present invention;

FIG. 6 illustrates a frequency component of a signal passing through an amplifier and a high pass filter of a T-DMB and DAB low IF receiver according to an embodiment of the present invention;

FIG. 7a illustrates a simplified block diagram of a dual band T-DMB and DAB low IF receiver according to an embodiment of the present invention; and

FIG. 7b illustrates a simplified block diagram of a dual band T-DMB and DAB low IF receiver comprising a high pass filter according to an embodiment of the present invention.

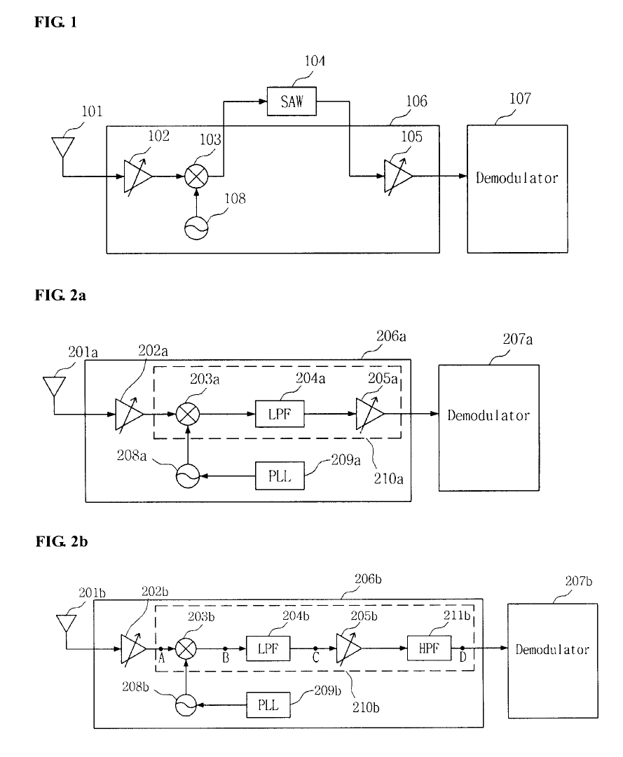

### DETAILED DESCRIPTION OF EMBODIMENTS

Embodiments of the present invention will be described in a more detailed manner with reference to the drawings.

FIG. 2a illustrates a simplified block diagram of a T-DMB and DAB low IF receiver according to an embodiment of the present invention.

The receiver comprises an LNA 202a, an image rejection down-conversion mixer 203a, a low pass filter 204a, an amplifier 205a, a local oscillator 208a, a phase-locked loop 209a, and a high pass filter (not shown) disposed within a portion 210a marked with a dotted line. The receiver is particularly a T-DMB and DAB low IF receiver in which the LNA 202a, the image rejection down-conversion mixer 203a, the low pass filter 204a, the amplifier 205a, the local oscillator 208a, the phase-locked loop 209a, and the high pass filter (not shown) are integrated into a single chip, i.e., a receiver chip 206a.

An antenna 201 a receives a RF signal and transmits the RF signal to the LNA 202a that suppresses a noise signal and amplifies the RF signal. An output signal of the LNA 202a is transmitted to the image rejection down-conversion mixer 203a that removes an image frequency component and down converts a frequency band of the RF signal into a low IF band.

The low pass filter 204a that filters a signal at a low frequency band receives an output signal of the image rejection down-conversion mixer 203a. An output signal of the low pass filter 204a is transmitted to the amplifier 205a.

The demodulator 207 receives an output signal of the receiver chip 206a.

The local oscillator 208a generates a frequency that allows the image rejection down-conversion mixer 203a to perform the down-conversion of the RF signal into the low IF signal. The generated frequency is provided to the image rejection down-conversion mixer 203a. The phase-locked loop 209a supplies a signal to the local oscillator 208a to move and lock the frequency generated by the local oscillator 208a.

The above-described receiver configuration allows the integration of the LNA 202a, the image rejection down-conversion mixer 203a, the low pass filter 204a, the amplifier 205a, the local oscillator 208a, the phase-locked loop 209a, and the high pass filter (not shown) into the single receiver chip 206a.

FIG. 2b illustrates an exemplary location of the high pass filter within the portion 210a marked with the dotted line in FIG. 2a in accordance with an embodiment of the present invention.

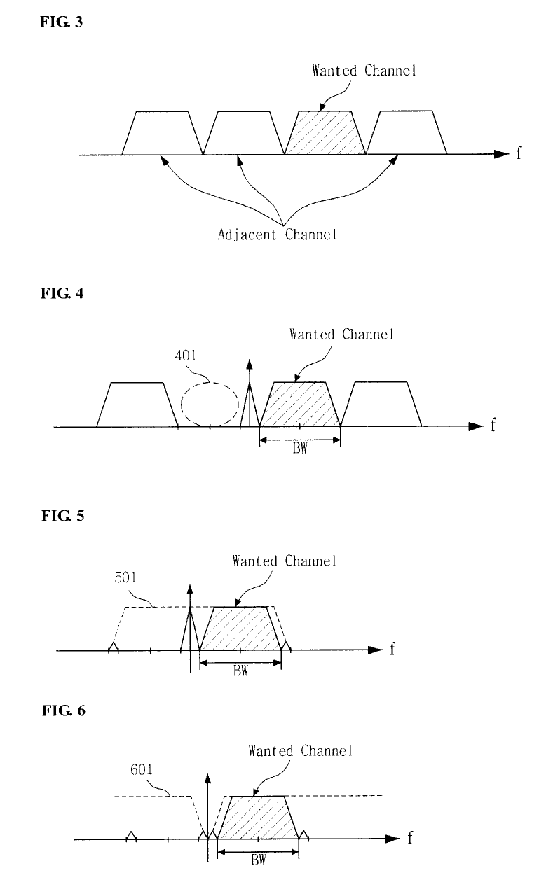

Effects obtained when the dotted portion 210a comprises the high pass filter are described in the embodiment illustrated in FIG. 2b with reference to FIGS. 3 to 6 to enhance the understanding of the description.

The high pass filter may be provided in multiple numbers (e.g., more than one) at any regions within the dotted portion 210a. One or more than one high pass filter may be placed at a terminal next to the image rejection down-conversion mixer 203a and/or the low pass filter 204a.

As described above, the dotted portion 210a comprises the high pass filter, and FIG. 2b particularly illustrates the case that the high pass filter 211b is disposed at a terminal next to an amplifier 205b.

FIGS. 3 to 6 illustrate diagrams to describe sequential operations of rejection a SAW filter without degrading the performance of the T-DMB and DAB low IF receiver when the dotted portion 210b comprises the high pass filter 211 as illustrated in FIG. 2b. Particularly, the diagrams illustrated in FIGS. 3 to 6 are to describe a frequency band processed for each operation.

FIG. 3 illustrates a frequency component at an output terminal A of an LNA 202b. In FIG. 3, a block with diagonal lines represents a wanted channel, while other plane blocks represent adjacent channels.

FIG. 4 illustrates a frequency component at an output terminal B of an image rejection down-conversion mixer 203b. The image rejection down-conversion mixer 203b down converts a frequency band of the frequency component at the output terminal A into a low IF band and removes a negative frequency region 401, which is an image frequency band.

FIG. 5 illustrates a frequency component at an output terminal C of a low pass filter 204b. The low pass filter 204b filters a portion marked with a dotted line 501 and removes frequency components except for a low frequency band.

FIG. 6 illustrates a frequency component at an output terminal D of the high pass filter 211b. The high pass filter 211b removes the low frequency component of the signal that has passed through the image rejection down-conversion mixer 203b, the low pass filter 204b and the amplifier 205b.

The high pass filter 211b is to remove a DC component that is usually generated during those processes including the amplification of the received RF signal at an antenna 201b and mixing thereof.

The above configuration allows the removal of the SAW filter without degrading the performance of the receiver, and thus, the receiver can be manufactured at low costs and easily integrated into a single chip.

The high pass filter 211b has a cut-off frequency of about 0.192 MHz or less.

A guard band is set between the frequency bands to separate usage bands of individual signals. Although a range of the frequency at the guard band varies from country to country using a frequency resource, the guard band generally has a minimum frequency of about 0.192 MHz or 0.176 MHz.

In the present embodiment, the cut-off frequency of the high pass filter 211b is set at about 0.192 MHz or less. Thus, the high pass filter 211b can filter a signal of the wanted channel from signals of the adjacent channels while removing a DC signal.

The high pass filter 211b may also function as a DC offset calibrator that calibrates a DC offset because the DC offset calibrator has a function as the high pass filter.

Generally, the DC offset calibrator detects the DC offset at an output terminal of a receiver, generates a DC offset calibration signal based on the DC offset detection, and supplies the DC offset calibration signal to a DC offset compensated amplifier of the DC offset calibrator to thereby remove the DC offset.

The removal of the DC offset by the DC offset calibrator provides substantially the same effect as the removal of the frequency component at the low frequency band by the high pass filter.

The DC offset calibrator can generate a loop within the receiver, and the loop type DC offset calibrator can remove the frequency component at the low frequency band as similar to the high pass filter.

The DC offset calibrator as described above is one exemplary type, and can be configured in various types within the receiver.

The DC offset calibration loop of the DC offset calibrator has a cut-off frequency of about 0.192 MHz or less.

The LNA 202b and the amplifier 205b may comprise a programmable gain amplifier or a variable gain amplifier. Although not illustrated, an automatic gain controller (AGC) adjusts amplification gains of the LNA 202b and the amplifier 205b.

For a signal at a certain frequency band, an information contained signal section is not often consecutive, and an information contained section and a null section that does not contain information usually coexist. The magnitude of the signal at the null section is usually smaller than that at the information contained section. Thus, if the AGC (not shown) operates at the null section, the amplification gain of the LNA 202b or the amplifier 205b at the null section increases. The increasing amplification gain is often maintained even at the information contained section after the null section. As a result, it is often difficult to maintain the magnitude of the signal at the received information contained section.

The AGC supplies a gain control signal that maintains a consistent level of the gain of the LNA 202b or the amplifier 205b according to the magnitude of the received RF signal at the receiver.

A null control signal controls the gain control signal according to the null section of the received RF signal at the receiver.

More specifically, the null control signal controls the gain control signal according to the null section, and the gain control signal controls the amplification gain of the LNA 202b or the amplifier 205b according to the magnitude of the signal (i.e., the RF signal).

Due to the gain control signal and the null control signal, the gain of the LNA 202b or the amplifier 205b can be maintained at a consistent level.

The T-DMB and DAB low IF receiver according to the embodiment of the present invention receives a range of frequencies at the Band-III of the frequency spectrum between about 174 MHz and about 245 MHz or at the L-band of the frequency spectrum between about 1,450 MHz and about 1,492 MHz. After receiving the aforementioned range of frequencies at the Band-III or L-band of the frequency spectrum, the T-DMB and DAB low IF receiver supplies a range of frequencies between about 0.768 MHz and about 0.960 MHz as a center frequency to the output terminal of the receiver.

A band width of the frequency at the output terminal of the receiver in the present embodiment is about 1.536 MHz. The frequency at the output terminal of the receiver according to the embodiment of the present invention is limited to about 768 kHz or more because a part of the frequency component at the output terminal of the receiver is likely to enter into the negative frequency region when the center frequency is about 768 kHz or less in the case that the band width of the frequency at the output terminal of the receiver is about 1.536 MHz.

Also, according to the embodiment of the present invention, an upper limit of the center frequency at the output terminal of the receiver is about 0.960 MHz. The reason for setting the upper limit is because when the center frequency is about 0.960 MHz or more, unwanted adjacent signals may also be comprised therein since the guard band has the minimum frequency of about 0.192 MHz or 0.176 MHz according to the specification set differently from country to country using a frequency resource.

Particularly, the output terminal of the receiver may have a center frequency of about 850 kHz.

A demodulator 207b receives a signal from the output terminal of the receiver chip 206b.

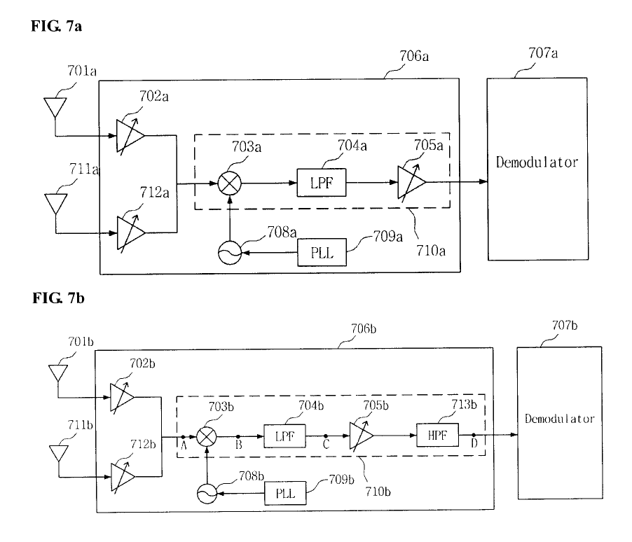

FIG. 7a illustrates a simplified block diagram of a dual band T-DMB and DAB low IF receiver according to an embodiment of the present invention.

In the present embodiment, the receiver comprises a first LNA 702a, a second LNA 712a, an image rejection down-conversion mixer 703a, a low pass filter 704a, an amplifier 705a, a local oscillator 708a, a phase-locked loop 709a, and a high pass filter (not shown) disposed within a portion 710a marked with a dotted line. The receiver is particularly a dual band T-DMB and DAB low IF receiver in which the first and second LNAs 702a and 712a, the image rejection down-conversion mixer 703a, the low pass filter 704a, the amplifier 705a, the local oscillator 708a, the phase-locked loop 709a, and the high pass filter (not shown) are integrated into a single chip, i.e., a receiver chip 706a.

A first antenna 701 a receives a first RF signal and transmits the first RF signal to the first LNA 702a that suppresses a noise signal and amplifies the first RF signal. A second antenna 711a receives a second RF signal and transmits the second RF signal to the second LNA 712a that suppresses a noise signal and amplifies the second RF signal.

An output signal of the first LNA 702a and an output signal of the second LNA 712a are transmitted to the image rejection down-conversion mixer 703a that removes an image frequency component and performs the down-conversion of a frequency band pertained to each of the first and second RF signals into a low IF band.

The low pass filter 704a that filters a signal at a low frequency band receives an output signal of the image rejection down-conversion mixer 703a. An output signal of the low pass filter 704a is transmitted to the amplifier 705a.

The demodulator 707a receives an output signal of the receiver chip 706a.

The local oscillator 708a generates a frequency that allows the image rejection down-conversion mixer 703a to down convert the first and second RF signals into the low IF signals. The generated frequency is provided to the image rejection down-conversion mixer 703a. The phase-locked loop 709a supplies a signal to the local oscillator 708a to move and lock the frequency generated by the local oscillator 708a.

The above-described receiver configuration allows the integration of the first and second LNAs 702a and 712a, the image rejection down-conversion mixer 703a, the low pass filter 704a, the amplifier 705a, the local oscillator 708a, the phase-locked loop 709a, and the high pass filter disposed within the dotted portion 710a into the single receiver chip 706a.

According to the above-described configuration, the receiver can receive frequencies at two bands and simultaneously, the SAW filter can be removed from the receiver without degrading the performance of the receiver. Thus, the receiver can be manufactured at low costs and easily integrated into a single chip.

FIG. 7b illustrates an exemplary location of the high pass filter within the portion 710a marked with the dotted line in FIG. 7a in accordance with an embodiment of the present invention.

To enhance the understanding of the description, effects obtained when the dotted portion 710a comprises the high pass filter are described in the embodiment illustrated in FIG. 7b with reference to FIGS. 3 to 6 referred to describe FIG. 2b.

The high pass filter may be provided in multiple numbers (e.g., more than one) at any regions within the dotted portion 710a. One or more than one high pass filter may be placed at a terminal next to the image rejection down-conversion mixer 703a and/or the low pass filter 704a.

A portion 710b marked with a dotted line is substantially the same as the portion 210b marked with the dotted line in FIG. 2B.

Hence, FIGS. 3 to 6 illustrate diagrams to describe sequential operations of rejection a SAW filter without degrading the performance of the T-DMB and DAB low IF receiver. Particularly, the diagrams illustrated in FIGS. 3 to 6 are to describe a frequency band processed for each operation at the dotted portion 710b. Since the sequential operations at the dotted portion 710b are substantially the same as that of FIG. 2b, the detailed description thereof will be omitted.

A high pass filter 713b is to remove a DC component that is usually generated during those processes including the amplification of the received first and second RF signals respectively at first and second antennas 701b and 711b and mixing thereof.

The above configuration allows the removal of the SAW filter without degrading the performance of the receiver, and thus, the receiver can be manufactured at low costs and easily integrated into a single chip.

The high pass filter 713b has a cut-off frequency of about 0.192 MHz or less.

A guard band is set between the frequency bands to separate usage bands of individual signals. Although a range of the frequency at the guard band varies from country to country using a frequency resource, the guard band generally has a minimum frequency of about 0.192 MHz or 0.176 MHz.

In the present embodiment, the cut-off frequency of the high pass filter 713b is set at about 0.192 MHz or less. Thus, the high pass filter 713b can filter a signal of a wanted channel from signals of adjacent channels while removing a DC signal.

The high pass filter 713b may also function as a DC offset calibrator that calibrates a DC offset because the DC offset calibrator has a function, as the high pass filter.

Generally, the DC offset calibrator detects the DC offset at an output terminal of a receiver, generates a DC offset calibration signal based on the DC offset detection, and supplies the DC offset calibration signal to a DC offset compensated amplifier of the DC offset calibrator to thereby remove the DC offset.

The removal of the DC offset by the DC offset calibrator provides substantially the same effect as the removal of the frequency component at the low frequency band by the high pass filter.

The DC offset calibrator can generate a loop within the receiver, and the loop type DC offset calibrator can remove the frequency component at the low frequency band as similar to the high pass filter.

The DC offset calibrator as described above is one exemplary type, and can be configured in various types within the receiver.

The DC offset calibration loop of the DC offset calibrator has a cut-off frequency of about 0.192 MHz or less.

The first and second LNAs 702b and 712b and the amplifier 705b may comprise a programmable gain amplifier or a variable gain amplifier. Although not illustrated, an automatic gain controller (AGC) adjusts gains of the first and second LNAs 702b and 712b and the amplifier 705b.

For a signal at a certain frequency band, an information contained signal section is not often consecutive, and an information contained section and a null section that does not contain information coexist. The magnitude of the signal at the null section is usually smaller than that at the information contained section. Thus, if the AGC (not shown) operates at the null section, the amplification gain of the first and second LNAs 702b and 712b or the amplifier 705b at the null section increases. The increasing amplification gain is often maintained even at the information contained section after the null section. As a result, it is often difficult to maintain the magnitude of the signal at the received information contained section.

The AGC supplies a gain control signal that maintains a consistent level of the gain of the first and second LNAs 702b and 712b or the amplifier 705b according to the magnitude of the received first and second RF signals at the receiver.

A null control signal controls the gain control signal according to the null section of the received first and second RF signals at the receiver.

More specifically, the null control signal controls the gain control signal according to the null section, and the amplification gain of the first and second LNAs 702b and 712b or the amplifier 705b according to the magnitude of the signal.

Due to the gain control signal and the null control signal, the gain of the first and second LNAs 702b and 712b or the amplifier 705b can be maintained at a consistent level.

According to the present embodiment, the first antenna 701b of the dual band T-DMB and DAB low IF receiver particularly receives a range of frequencies at the Band-III of the frequency spectrum between about 174 MHz and about 245 MHz, and the second antenna 711b thereof receives a range of frequencies at the L-band of the frequency spectrum between about 1,450 MHz and about 1,492 MHz.

A band width of the frequency at the output terminal of the receiver in the present embodiment is about 1.536 MHz. The frequency at the output terminal of the receiver according to the present embodiment is limited to about 768 kHz or more because a part of the frequency component at the output terminal of the receiver is likely to enter into a negative frequency region when the center frequency is about 768 kHz or less in the case that the band width of the frequency at the output terminal of the receiver is about 1.536 MHz.

Also, an upper limit of the center frequency at the output terminal of the receiver is about 0.960 MHz. The reason for setting the upper limit is because when the center frequency is about 0.960 MHz or more, unwanted adjacent signals may also be comprised therein since the guard band has the minimum frequency of about 0.192 MHz or 0.176 MHz according to the specification set differently from country to country using a frequency resource.

The phase-locked loop 709b transmits the signal to the local oscillator 708b to allow the down-conversion of the received range of the signal frequencies at the Band-III or at the L-band into a range of the center frequency between about 0.768 MHz and about 0.960 MHz and the subsequent transmission of the down-converted signal to the output terminal of the receiver.

Particularly, the output signal of the receiver chip 706b has a center frequency of about 850 kHz.

Therefore, the dual band T-DMB and DAB low IF receiver receives the signals at the two frequency bands (i.e., the Band-III and the L-band).

In the case of receiving the signal at the Band-III of the frequency spectrum, the signal goes sequentially through the first antenna 701b, the first LNA 702b, the image rejection down-conversion mixer 703b, the low pass filter 704b, the amplifier 705b, and the high pass filter 713b. In the case of receiving the signal at the L-band of the frequency spectrum, the signal goes through the second antenna 711b, the second LNA 712b, the image rejection down-conversion mixer 703b, the low pass filter 704b, the amplifier 705b, and the high pass filter 713b.

The demodulator 707b receives a signal from the output terminal of the receiver chip 706b.

According to various embodiments of the present invention, the T-DMB and DAB low IF receiver can reduce the manufacturing costs and allow an easier implementation of the single chip integration process by being able to remove the conventional SAW filter.

According to various embodiments of the present invention, the dual band T-DMB and DAB low IF receiver can receive the signals at the two frequency bands and simultaneously remove the conventional SAW filter. Thus, the manufacturing costs can be reduced, and the receiver can be easily integrated into a single chip.

The performance of the T-DMB and DAB low IF receiver and the dual band T-DMB and DAB low IF receiver is not degraded even if the SAW filter is removed.

The invention being thus described, it will be obvious that the same may be varied in many ways. Such variations are not to be regarded as a departure from the spirit and scope of the invention and all such modifications as would be obvious to one skilled in the art are intended to be included within the scope of the following claims.

What is claimed is:

1. A terrestrial-digital multimedia broadcasting (T-DMB) and digital audio broadcasting (DAB) low intermediate frequency (IF) receiver comprising:
a low noise amplifier (LNA) suppressing a noise signal of a received radio frequency (RF) signal and amplifying the received RF signal, wherein the received RF signal includes a T-DMB signal or a DAB signal;
an image rejection down-conversion mixer converting a frequency band of the RF signal outputted from the LNA into a low IF band;
a low pass filter filtering a low frequency band of a signal outputted from the image rejection down-conversion mixer;
an amplifier amplifying a signal outputted from the low pass filter;
a local oscillator generating a frequency for the down-conversion and supplying the frequency to the image rejection down-conversion mixer;
a phase-locked loop moving the frequency of the local oscillator to a certain frequency and locking the certain frequency; and
at least one high pass filter disposed within a signal passage comprising the image rejection down-conversion mixer, the low pass filter and the amplifier and removing a low frequency component generated at the signal passage,
wherein the LNA, the image rejection down-conversion mixer, the low pass filter, the amplifier, the local oscillator, the phase-locked loop, and the high pass filter are integrated in a monolithic semiconductor integrated circuit substrate.

2. The T-DMB and DAB low IF receiver of claim 1, wherein the high pass filter has a cut-off frequency of about 0.192 MHz or less.

3. The T-DMB and DAB low IF receiver of claim 1, wherein the received RF signal comprises a signal at one frequency band of a Band-III ranging between about 174 MHz and about 245 MHz or an L-band ranging between about 1,450 MHz and about 1,492 MHz.

4. A terrestrial-digital multimedia broadcasting (T-DMB) and digital audio broadcasting (DAB) low intermediate frequency (IF) receiver comprising:
a low noise amplifier (LNA) suppressing a noise signal of a received radio frequency (RF) signal and amplifying the received RF signal, wherein the received RF signal includes a T-DMB signal or a DAB signal;
an image rejection down-conversion mixer converting a frequency band of the RF signal outputted from the LNA into a low IF band;
a low pass filter filtering a low frequency band of a signal outputted from the image rejection down-conversion mixer;
an amplifier amplifying a signal outputted from the low pass filter;
a local oscillator generating a frequency for the down-conversion and supplying the frequency to the image rejection down-conversion mixer;
a phase-locked loop moving the frequency of the local oscillator to a certain frequency and locking the certain frequency; and
a DC offset calibrator removing a frequency component at a low frequency band,
wherein the LNA, the image rejection down-conversion mixer, the low pass filter, the amplifier, the local oscillator, the phase-locked loop, and the DC offset calibrator are integrated in a monolithic semiconductor integrated circuit substrate.

5. The T-DMB and DAB low IF receiver of claim 4, wherein the DC offset calibrator has a cut-off frequency of about 0.192 MHz or less.

6. The T-DMB and DAB low IF receiver of claim 4, wherein the received RF signal comprises a signal at one frequency band of a Band-III ranging between about 174 MHz and about 245 MHz or an L-band ranging between about 1,450 MHz and about 1,492 MHz.

7. A dual band terrestrial-digital multimedia broadcasting (T-DMB) and digital audio broadcasting (DAB) low intermediate frequency (IF) receiver comprising:
a first low noise amplifier (LNA) suppressing a noise signal of a received first radio frequency (RF) signal and amplifying the received first RF signal, wherein the received first RF signal includes a T-DMB signal;
a second low noise amplifier (LNA) suppressing a noise signal of a received second radio frequency (RF) signal and amplifying the received second RF signal, wherein the received second RF signal includes a DAB signal;
an image rejection down-conversion mixer converting frequency bands of the first and second RF signals respectively outputted from the first and second LNAs into a low IF band;
a low pass filter filtering a low frequency band of a signal outputted from the image rejection down-conversion mixer;
an amplifier amplifying a signal outputted from the low pass filter;
a local oscillator generating a frequency for the down-conversion and supplying the frequency to the image rejection down-conversion mixer;
a phase-locked loop moving the frequency of the local oscillator to a certain frequency and locking the certain frequency; and
at least one high pass filter disposed within a signal passage comprising the image rejection down-conversion mixer, the low pass filter and the amplifier and removing a low frequency component generated at the signal passage, wherein the first and second LNAs, the image rejection down-conversion mixer, the low pass filter, the amplifier, the local oscillator, the phase-locked loop, and the high pass filter are integrated in a monolithic semiconductor integrated circuit substrate.

8. The dual band T-DMB and DAB low IF receiver of claim 7, wherein the high pass filter has a cut-off frequency of about 0.192 MHz or less.

9. The dual band T-DMB and DAB low IF receiver of claim 7, wherein the first RF signal comprises a signal at a Band-III frequency band ranging between about 174 MHz and about 245 MHz; and the second RF signal comprises a signal at an L-band frequency band ranging between about 1,450 MHz and about 1,492 MHz.

10. A dual band terrestrial-digital multimedia broadcasting (T-DMB) and digital audio broadcasting (DAB) low intermediate frequency (IF) receiver comprising:
a first low noise amplifier (LNA) suppressing a noise signal of a received first radio frequency (RF) signal and amplifying the received first RF signal, wherein the received first RF signal includes a T-DMB signal;
a second low noise amplifier (LNA) suppressing a noise signal of a received second radio frequency (RF) signal and amplifying the received second RF signal, wherein the received second RF signal includes a DAB signal;
an image rejection down-conversion mixer converting a frequency band of the RF signal outputted from the LNA into a low IF band;
a low pass filter filtering a low frequency band of a signal outputted from the image rejection down-conversion mixer;
an amplifier amplifying a signal outputted from the low pass filter;
a local oscillator generating a frequency for the down-conversion and supplying the frequency to the image rejection down-conversion mixer;
a phase-locked loop moving the frequency of the local oscillator to a certain frequency and locking the certain frequency; and
a DC offset calibrator removing a frequency component at a low frequency band, wherein the first and second LNAs, the image rejection down-conversion mixer, the low pass filter, the amplifier, the local oscillator, the phase-locked loop, and the DC offset calibrator are integrated in a monolithic semiconductor integrated circuit substrate.

11. The dual band T-DMB and DAB low IF receiver of claim 10, wherein the DC offset calibrator has a cut-off frequency of about 0.192 MHz or less.

12. The dual band T-DMB and DAB low IF receiver of claim 10, wherein the first RF signal comprises a signal at a Band-III frequency band ranging between about 174 MHz and about 245 MHz; and the second RF signal comprises a signal at an L-band frequency band ranging between about 1,450 MHz and about 1,492 MHz.
